(19) United States
(12) Patent Application Publication
(10) Pub. No.: US 2024/0090646 A1
(43) Pub. Date: Mar. 21, 2024

(54) COSMETIC BLENDER AND METHOD OF USE

(71) Applicant: John H. SHADDUCK, Menlo Park, CA (US)

(72) Inventor: John H. SHADDUCK, Menlo Park, CA (US)

(21) Appl. No.: 18/469,828

(22) Filed: Sep. 19, 2023

Related U.S. Application Data
(60) Provisional application No. 63/376,214, filed on Sep. 19, 2022.

(51) Int. Cl. A45D 34/04; A45D 40/26; B29C 44/12; B29C 44/56; B29C 59/02

(52) U.S. Cl. CPC A45D 34/04; A45D 40/26; B29C 44/12; B29C 44/5627; B29C 59/02; A45D 2200/1018; B29L 2031/718

(57) ABSTRACT

Cosmetic blenders and applicators, and more particularly to a soft, resilient blender system that includes an open-cell memory foam surface portion that is easily cleanable or optionally disposable in combination with a resilient core and a fluid impermeable boundary between the surface portion and the resilient core. Further, variations of the blender provide a patterned surface structures for makeup pickup and release together tamping features and user-controlled variable stiffness surface tamping features.

### RELATED APPLICATION INFORMATION

This application is a non-provisional application of U.S. Provisional Application No. 63/376,214 filed on Sep. 19, 2022. The entirety of which is incorporated by reference. This application is also related to application Ser. No. 16/727,605 filed on Dec. 26, 2019, the entirety of which is incorporated by reference.

### BACKGROUND OF THE INVENTION

1. Field of the Invention. The present invention relates to cosmetic blenders and applicators, and more particularly to a soft, resilient blender system that includes an open-cell memory foam surface component that is easily cleanable or optionally disposable in combination with a core component that is fluid impermeable. Further, variations of the blender provide (i) patterned surface structures for makeup pickup and release together tamping features, (ii) user-controlled variable stiffness surface tamping features, (iii) actuated surface tamping features, (iv) accelerometer controlled surface tamping actuators, (v) wireless communication with smartphones and the like for controlling actuators, recording use and providing users with indications of optimal methods of use, (vi) sensors for sensing skin contacting parameters, and (vii) light and/or thermal emitters for enhancing blending and setting of cosmetic materials.

2. Description of the Background Art. Professional makeup artists often work in fast-paced environments where there is a need to apply makeup to several models or actors in rapid succession, particularly in the fashion, theatre, and television industries. Such makeup artists may spend a considerable amount of time cleaning and preparing their makeup tools when working with multiple clients over a short period of time. With the advent of new technologies in high-resolution digital cameras and video, there is an increasing need for professionally blended face and body makeup.

Cosmetic applicators known as makeup sponges or blenders are well known and are a mainstay of a makeup artist's toolkit. The commercially available makeup sponges or blenders typically consist of a latex or urethane foam sponge 50, as shown in FIG. 3, wherein the sponge consists of a uniform density open cell foam and may have a variety of shapes and sizes.

There are several disadvantages involving the use of the currently available sponges and blenders. In normal use, a sponge or blender is dabbed continuously against the recipient's skin where cosmetic materials, such as contour makeup 60 (FIG. 3), are picked up by open cells of the blender surface and then released back onto the skin surface as the blender is moved to thus blend the cosmetic material.

First, many blenders are impregnated with large amounts of cosmetic material during use, which can be wasteful and costly. If too much cosmetic material is impregnated in the applicator, it may be difficult to blend the cosmetic material uniformly. On the other hand, if the amount of cosmetic material retained by the applicator is too small, then blending may take longer and still may not be uniform. The designs of blenders have been adjusted to improve the amount of cosmetic material impregnated into the sponge surface during use, mainly by experimenting with the size and density of pores in the open cell foam that comprises the blender. Typically, the open cell foam blenders that are commercially available have very small pores which are adapted to hold water before use to moisturize the sponge. In use, the dabbing motion can cause the cosmetic material to migrate through the entire sponge. Thereafter, cleaning the sponge is problematic as the makeup material can migrate throughout the sponge. Further, the complete drying of such blender sponges can take hours due to the very small pore size in such blenders.

Further, from the viewpoint of hygiene, bacteria can easily grow inside the pores of the blender, especially when liquid cosmetic material is applied, because the material can permeate through the entire foam body of the applicator.

Another potential disadvantage of currently available open cell foam blenders relates to their use with anticipated new forms of makeup materials, some of which are being contemplated by the author and are termed herein as microbiome cosmetics. While not widely used today, it is anticipated that makeup materials such as primers, etc., will be used that carry living microorganisms, i.e., the microbiome. When using an open cell blender after the application of microbiome cosmetics, it will be inevitable that such living microorganisms will migrate throughout the sponge, which again may make thorough cleaning and drying more important. Further, it is possible that such applicators would require regulatory clearance for sterilization when used to apply microbiome materials to a recipient's face.

An additional disadvantage of current open cell foam blenders relates to the uniformity of the resilient open cell foam material and the slow rebound of such memory foam from a compressed or tensioned state to its repose memory shape. In use, a makeup artist also could find it useful to have different density foams with different force/compression characteristics for blending in a different area of a recipient's face, for example, softer foam for use around the eyes and less soft foam for use in other locations. Further, it would also be very useful to have faster rebounding foam which could speed up the blending of makeup.

What is needed is:
a cosmetic applicator or blender configured for very rapid cleaning and drying after each use to provide for completely hygienic makeup applications;
a cosmetic applicator or blender or sponge with uniform, microfabricated pores suited for picking up makeup without excessive impregnation of the makeup into the applicator to limit waste of cosmetic materials;
a cosmetic applicator or blender adapted for use with microbiome cosmetics which carries limited volumes of such live cultures to conserve expensive products and that is easily cleanable or sterilizable;
a cosmetic applicator or blender with a surface structure adapted to absorb a specific amount of water to allow for a consistent level of moisture in the applicator for specific types of makeup;
a cosmetic applicator or blender for makeup artists that can be inexpensive and adapted for single use that has all needed features for controlled moisture content, feel on the skin, and adapted for limiting waste of cosmetic materials;
a cosmetics applicator or blender that provides a makeup-carrying surface with a first portion configured to pick up makeup during blending and a second portion for tamping cosmetic material into foundation cosmetics and skin;
a cosmetic applicator with at least one actuator for altering the force/deformation characteristics of the blender for differential blending/dabbing with a single applicator;
a cosmetic applicator or blender with ultrasound actuators, linear resonant actuators (LRAs), eccentric rotating mass actuators (ERMs), or the like for enhanced tamping of cosmetic material with high-frequency movement or vibration;
a cosmetic applicator or blender with powered actuators and a communication link to a smartphone, tablet, or computer to adjust operating parameters;
a cosmetic applicator or blender with sensors, such as a pressure sensor, accelerometer, etc., and an optional communication link to a remote device and/or the cloud to store user data and/or receive operating instructions or suggestions; and
a cosmetic blender carrying a processor or control system configured to activate actuators only when contacting skin as the user dabs the blender.

The several variations of the present invention described below provide a cosmetics applicator or blender that solves the aforementioned problems.

### SUMMARY OF THE INVENTION

The features described herein, various novel details of construction and combinations of parts, and other advantages, will be described with reference to the accompanying drawings and claims. It is understood that the particular methods and devices conveying the inventive features are shown by way of illustration and not as a limitation of the invention. The principles and features of this invention may be employed in various and numerous embodiments without departing from the scope of the invention.

The present disclosure includes improved cosmetic applicators. For example, such an applicator can include a resilient body shaped for gripping with the fingers of a user; a surface of the resilient body comprising a first resilient portion and a second resilient portion that forms a pattern in the first resilient portion, wherein the first resilient portion has a first functional parameter and the second resilient portion has a second functional parameter.

In one variation of the cosmetic applicator, the first functional parameter and the second functional parameter are selected from a group of material density, open cell characteristics, closed cell characteristics, material density, elastic modulus, hydrophobic characteristics, hydrophilic characteristics, oleophobic characteristics, oleophilic characteristics, elastic rebound characteristics, material thickness, and color coding.

The pattern can be selected from a group of adjacent lines, dots, squares, polygonal shapes, and free-form shapes. In an additional variation, the surface of the resilient body in a repose state is smooth. Alternatively, or in combination, the surface of the resilient body in a repose state is textured.

In an additional variation, an outer surface of the first resilient portion is raised above an outer surface of the second resilient portion.

The cosmetic applicator can be configured such that a surface portion is removable from a core portion of the resilient body. In variations of the device, a surface portion comprises a first layer and a second layer having different porous characteristics.

In an additional variation, the core portion has a fluid impermeable surface.

Another variation of a cosmetic applicator can include a resilient body shaped for gripping with fingers of a user; a surface portion of the resilient body comprising a first elastomeric portion and a second elastomeric portion arranged in a pattern within the first elastomeric portion, wherein the first elastomeric portion has an outer surface that is raised above an outer surface of the second elastomeric portion.

In one variation, the surface portion includes a foam layer that overlies a patterned inner surface, wherein said foam layer is detachable from the resilient body. The foam layer can be a uniform material. Alternatively, foam layer can comprise first and second foam materials with different porosities.

Another variation of a cosmetic applicator includes a body shaped for gripping with the fingers of a user; a surface portion of the body having at least one resilient characteristic; and a bladder in an interior of the body and an actuator carried in the body for adjusting a fluid pressure in the bladder to alter the at least one resilient characteristic of the surface portion.

The cosmetic applicator can include an actuator that is a manually compressible secondary bladder.

Another variation of a cosmetic applicator includes a body shaped for gripping with the fingers of a user; a surface portion of the body comprising a resilient material; and an actuator carried in the body for actuating a surface portion of the body.

The actuator can be at least one of a fluidic actuator, a piezoelectric actuator, and a mechanical actuator. The cosmetic applicator can further include a control system for controlling operating parameters of the actuator. For example, the control system can be configured to send and receive a control signal from a remote device. In addition, the control signal can be transmitted wirelessly to and from the remote device. Variations include the remote device, a smartphone, tablet, a smartwatch and/or other networked personal electronic devices. The remote device can also comprise a computer and display.

In additional variations, the actuator is configured to apply forces generally outward from the surface portion of the body. The actuator can be configured to apply forces generally parallel to the surface portion of the body. In additional variations, the cosmetic applicator includes a plurality of actuators configured to apply forces generally parallel to the surface portion in different vectors.

Another variation of a cosmetic applicator includes a body shaped for gripping with the fingers of a user; a surface portion of the body comprising a resilient material; and an accelerometer carried in the body for sensing movements of the body and providing signals of said movements.

The cosmetic applicators described herein can further include a battery carried by the body coupled to the accelerometer. In an additional variation, the cosmetic applicator further includes a control system configured to receive said signals to thereby control an actuator carried by the body. The control system can be configured to receive said signals to thereby control an indicator mechanism carried by the body. In variations, the indicator provides at least one of an aural signal, a visual signal and a tactile signal.

Yet another variation of a cosmetic applicator includes a body shaped for gripping with the fingers of a user; a surface portion of the body comprising a resilient material; and at least one actuator carried by the body causing high frequency movement of a surface portion of the body. The cosmetic applicator can include a body that comprises a core component carrying the actuator and a detachable surface component comprising at least in part a porous material.

The present disclosure also includes methods for/related to blending cosmetic materials on a user's skin. For example, one such method includes providing a resilient body having a surface formed by a first resilient portion and a second resilient portions forming a pattern in the first resilient portion, wherein the first resilient portion is porous and is more easily compressible that the second resilient portion; dabbing the surface portion against cosmetics on the user's skin to blend such cosmetics, wherein such dabbing is adapted to cause the first resilient portion to collect and redeposit a cosmetic material and to cause the second resilient portion to tamp the cosmetic material into cosmetics and the recipient's skin.

The method also includes providing instructions to a user to instruct the user to carry out dabbing of the surface portion against cosmetics on the user's skin.

### BRIEF DESCRIPTION OF THE DRAWINGS

In order to better understand the invention and to see how it may be carried out in practice, some preferred embodiments are next described, by way of non-limiting examples only, with reference to the accompanying drawings, in which like reference characters denote corresponding features consistently throughout similar embodiments in the attached drawings.

FIG. 1 is a perspective view of a cosmetic applicator or blender corresponding to the invention.

FIG. 2A is a perspective cutaway view of the blender of FIG. 1, showing an open cell surface component is removable from the fluid impermeable core component.

FIG. 2B is a sectional view of the resilient core component of the blender of FIGS. 1 and 2A and shows an open interior space in the core component.

FIG. 3 is a schematic view of a method of using a prior art sponge blender in dabbing cosmetic materials on a recipient's skin.

FIGS. 4A-4F are sectional views of a very small surface portion of the prior art blender of FIG. 3 during use showing the first and second dabs to illustrate the effect of tamping and lifting the blender.

FIG. 5A is a schematic view of a variation of a blender similar to that of FIGS. 1-2B with a patterned surface having first porous surface features adapted to controllably pick up cosmetic material during dabbing and second less porous surface features adapted to tamp cosmetic materials during dabbing.

FIG. 5B is a schematic view of another blender similar to that of FIG. 5A with a different pattern of features for cosmetic material pick up and tamping.

FIG. 5C is another variation blender of similar to that of FIGS. 5A-5B with a different pattern of features for cosmetic material pick up and tamping.

FIGS. 6A-6E are greatly enlarged sectional views of a surface portion of a blender of FIGS. 5A-5B showing the porous features for cosmetic material pick up and other features for tamping cosmetic material.

FIG. 7 is a schematic view of another blender variation that includes a fluidic actuator for providing or adjusting the tamping features in the blender surface.

FIG. 8A is a greatly enlarged sectional view of the surface of the blender of FIG. 7 showing the tamping features in a non-expanded form.

FIG. 8B is a sectional view of the tamping features of the blender surface of FIG. 8A in an expanded form.

FIG. 9 is a view of another blender variation with an internal bladder with adjustable fluid pressure for altering the resilience or stiffness of the blender surface.

FIG. 10 is a schematic view of another blender variation which includes at least one ultrasonic actuator together with a battery and control unit carried by a core portion of the blender and a finger-actuated switch for operating the ultrasonic actuators and they stand for recharging the battery in the blender.

FIG. 11 is a schematic view of the blender of FIG. 10 that carries an additional communication unit for wirelessly communicating with a smartphone and with the cloud.

FIG. 12 illustrates a method of using the blender of FIG. 11 in blending cosmetic materials on a recipient's skin.

FIG. 13 is a schematic view of another blender variation similar to that of FIG. 11 showing a plurality of actuators adapted for force application in different directions together with accelerometer for sensing movements of the blender and communicating with the control unit carried by the blender.

FIG. 14 illustrates a method of using the blender of FIG. 13 in blending cosmetic materials on a recipient's skin.

FIG. 15 shows the sectional view of another blender variation having a planar form with a surface comprising two surface layers having different porosity characteristics.

FIG. 16 is a great enlarged cutaway view of the portion of the first and second surface layers of FIG. 15 wherein the outermost layer comprises material fabricated by soft lithography or 3D printing to have uniform pore sizes adapted for controllably picking up cosmetic materials and wherein the second layer has different porosity characteristics which inhibit picking up cosmetic materials.

FIG. 17A illustrates a variation of a cosmetic blender comprising a monolithic applicator body.

FIG. 17B is the sectional view of the cosmetic blender of FIG. 17A taken along line 17B-17B of FIG. 17A rotated 90°.

FIG. 18A consists of sectional views of the applicator of FIG. 17A and a subject's skin and makeup illustrating a method of use.

FIG. 18B is an enlarged view of the applicator of FIG. 18A illustrating a method of the invention wherein the undulating surface assists in spreading makeup laterally on a subject's skin.

FIG. 19 is a transverse sectional view of the cosmetic blender of FIG. 17A taken along line 19-19 of FIG. 17A.

FIG. 20A is an enlarged cross-sectional view of an undulating surface of an applicator of the type shown in FIG. 17A.

FIG. 20B is a cross-sectional view of a variation or an undulating surface of an applicator.

FIG. 20C is a cross-sectional view of another variation or an undulating surface.

FIG. 20D is a cross-sectional view of another variation or an undulating surface.

FIG. 21 is a side view of another variation of a cosmetic applicator similar to that of FIG. 17A with an undulating surface with helical channels.

FIG. 22 is an enlarged perspective view of another variation of an undulating surface with individual peaks and valleys.

FIG. 23 is a cosmetic applicator with the undulating surface of FIG. 22 extending over one-half of the applicator surface.

FIG. 24 is another variation of a cosmetic applicator with an undulating surface extending over the entire applicator surface.

FIG. 25 is another variation of an applicator similar to that of FIG. 6E with an undulating surface of a fluid permeable layer overlying a fluid impermeable layer or boundary at an interface with a resilient core portion.

FIG. 26A is a first step in a method of making an applicator of the type shown in FIG. 25 with a surface fluid permeable layer, a fluid impermeable layer, and a resilient core, where the first step of FIG. 26A illustrates a liquid precursor of an open cell foam being poured into a mold around a mandrel having the shape of an eventual core portion,

FIG. 26B is a subsequent step illustrating the foam precursor after having transitioned into a block of an open cell foam in the mold around the mandrel.

FIG. 26C is a subsequent step illustrating the foam block and mandrel being removed from the mold.

FIG. 26D is a subsequent step illustrating the foam block being shaped with cutting tools into a final shape with an undulating surface and, optionally, a smooth surface portion.

FIG. 26E is a subsequent step illustrating the mandrel being removed from the shaped applicator surface portion.

FIG. 26F is a subsequent step illustrating an already shaped resilient core being partially inserted into the cavity of the shaped surface portion.

FIG. 26G is a subsequent step illustrating the resilient core fully inserted into the cavity of the shaped surface portion to make the applicator of FIG. 25.

### DESCRIPTION OF THE INVENTION

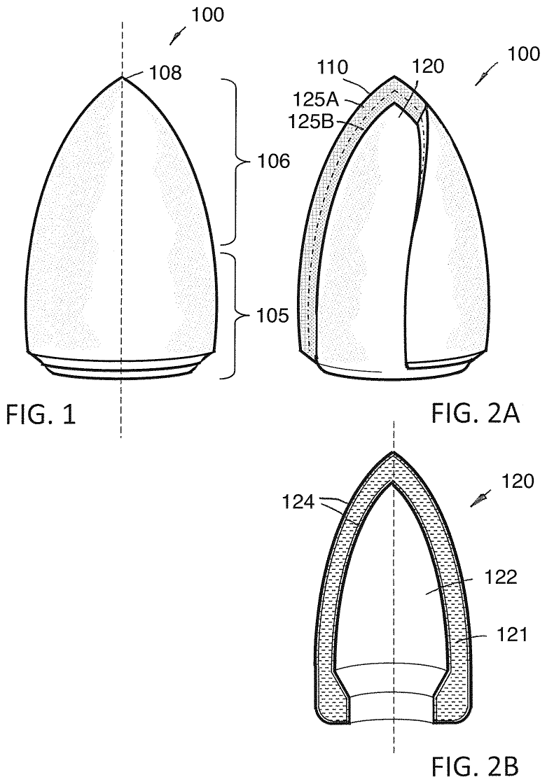

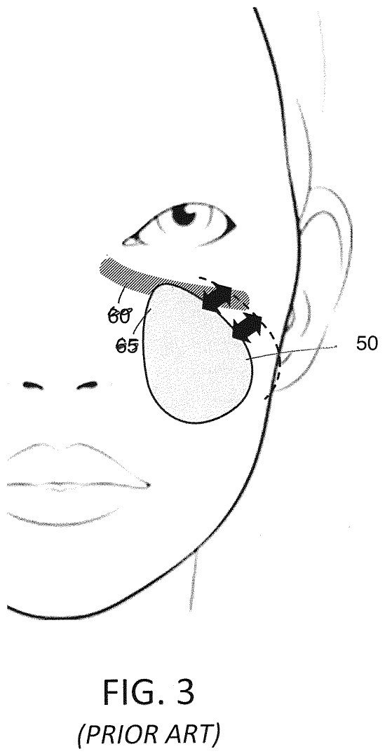

FIG. 1 shows a cosmetics applicator, tool or blender 100 corresponding to the invention which is adapted for gripping with a user's fingers and then typically used in a dabbing or stippling motion to blend and apply cosmetic materials to a recipient's face (cf. FIG. 3). The shape and contours of the blender can vary and in one embodiment shown in FIG. 1, the applicator has a proximal portion 105 that is generally gripped with the user's fingers and a distal portion 106 that tapers to a rounded or sharp apex 108. The blender or applicator of FIG. 1 comprises a soft, compressible, resilient body as can be easily understood. While the blender of FIG. 1 is rounded and tapers to distal apex 108, various flat, polygonal and planar variations are possible. The length dimension of the applicator 100 may range from about 20 mm to 60 mm but any dimensions are possible for different makeup blending purposes. Other shapes are described in additional embodiments below.

In FIG. 2A, it can be seen that the cosmetics applicator or blender 100 of FIG. 1 has a surface component or portion 110 that comprises a soft, resilient open cell structure and typically is an open cell foam or sponge, often called a memory form. In other variations, at least a portion of the surface component 110 can comprise other open cell structures such as a microfabricated polymer or a layer electrospun fibers, as will be described below. The surface component 110 interfaces with the core component or portion 120 of the blender 100, which also is soft and resilient. As can be seen in FIG. 2B, the core component 120 in one variation is an open cell foam 121 with open interior space 122. In this variation, the surfaces of the core component 120 comprise a fluid impermeable layer 124 (FIG. 2B). In other variations described below, the core component 120 can comprise a body or structure that is a foam block without the interior open space and is configured with the same compressibility and resilient characteristics with the fluid impermeable surface layer.

Now referring to FIG. 2A, in one variation, the open cell surface component 110 comprises a first outer layer 125A and the second inner layer 125B, which have different dimensions of the open cell structure and may also differ in material characteristics such as hydrophobicity. The first outer layer 125A is configured with open cells that have a selected dimension adapted to receive, carry and blend makeup materials therein as the blender surface is used in a dabbing fashion against the user's skin, as shown in FIG. 3. In one variation, the first outer layer 125A can have a thickness of 0.2 mm to 5.0 mm a more often from 0.5 mm to 2.5 mm. The mean dimension of open cells in the outer layer 125A can a range between 100 μm and 500 μm.

Still referring to FIG. 2A, this variation of blender 100 has a second inner layer 125B of the surface component 110 that comprises an open cell structure adapted to carry water in a selected volume to provide moisture for applying or blending makeup material carried transiently by the first outer layer 125A when dabbed the recipient's skin as described above. In one variation, the second inner layer 125B can have a thickness of 0.5 mm to 10.0 mm and more often from 2.0 mm to 5.0 mm. The mean dimension of an open cell in the second inner layer can range between 5 μm and 250 μm. In the embodiment illustrated in FIG. 2A, the mean dimension the open cells in the second inner layer 125B are significantly smaller than the mean dimension of the open cells in the first outer layer 125A, as the inner layer is configured to allow for the free flow water through both the first and second layers 125A, 125B. However, the smaller open cells of inner layer 125B are adapted to reduce or prevent the migration of makeup materials (powder or fluid) through the first outer layer 125A and into the second inner layer 125B. In some variations, the second inner layer 125B is designed with very small open cell dimensions that can receive water but entirely prevent the movement of makeup material into such open cells. As described above, the outer surface layer 124 of the core component 120 is fluid impermeable so that any fluid absorption and makeup migration is prevented following material and fluid impregnation of the surface component 110.

Further, still referring to FIG. 2A, the material of the second inner layer 125B can be a hydrophobic material that will accept the migration of water therein but has the tendency the repel retained water which then assists in moving water droplets outward through the surface component 110, for example, when the blender is squeezed. Silicone is an example of a hydrophobic material that can be used in the second inner layer 125B. In contrast, in one variation, the first outer layer 125A can be a substantially hydrophilic foam material that does not resist carrying small amounts of water or makeup fluids therein.

Thus, it can be understood from FIGS. 1 and 2A, the open cell surface component 110 comprises only a small fraction of the entire cubic volume of the applicator 100 when in its repose or non-compressed shape, as shown in FIGS. 1 and 2A. In one aspect of the invention, the open cell component 110 is less than 40% of the total spatial volume of the applicator or blender 100. More often, the total volume of the open cell component is less than 30% of the total spatial blender volume or less than 20% of the total spatial volume. In the embodiment shown in FIG. 1, the open cell component is less than 10% of the total spatial blender volume. The term spatial volume, as used herein, means the total volume of the spatial “envelope” defined by the blender without regard to the open interior space. The term total volume of the open cell component means the actual physical volume of such a component and not the volume of the envelope defined by the component.

Stated another way, in another aspect of the invention, it has been found that the retained water volume carried by the open cell structure (surface component) can be less than 20 mL or less than 10 mL and still provide adequate moisture for dabbing or blending of makeup. In contrast, prior art makeup sponges or blenders typically retain far greater volumes of water since the entire applicator is an open cell foam. Such applicators that retain significantly larger water volumes are undesirable since cleaning and drying such sponge-type applicators is time-consuming and may result in mold and bacteria growth in the sponge material if not properly cleaned and dried.

As can be understood from FIGS. 2A and 2B, after use, the outer blender component 110 can be removed from the core component 120. In one aspect of the invention, the makeup artist can simply dispose of the outer component 110 as it can be expensive. In another aspect of the invention, the makeup artist can clean, rinse and dry the outer component 110, which can be accomplished very quickly since there is a limited volume of open cell material that can carry water and makeup materials. The outer component 110 can be washed under a faucet and then also can be dried rapidly after squeezing out any water since the outer component has a very limited volume of open cells, and air can be exposed on all sides of the component 110.

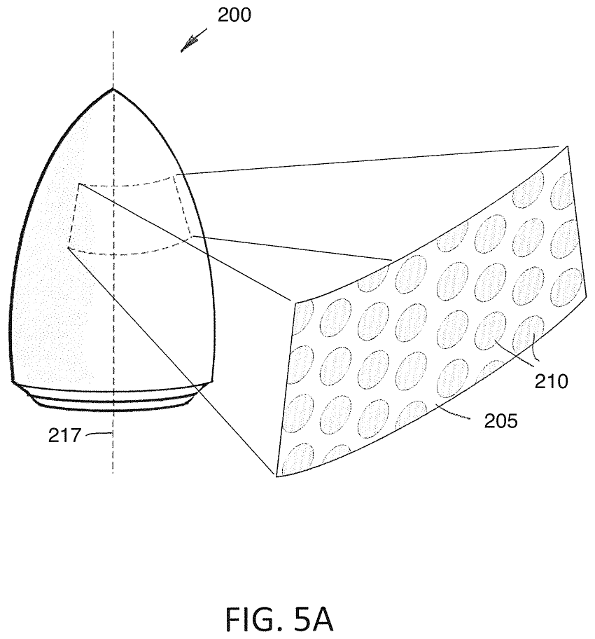

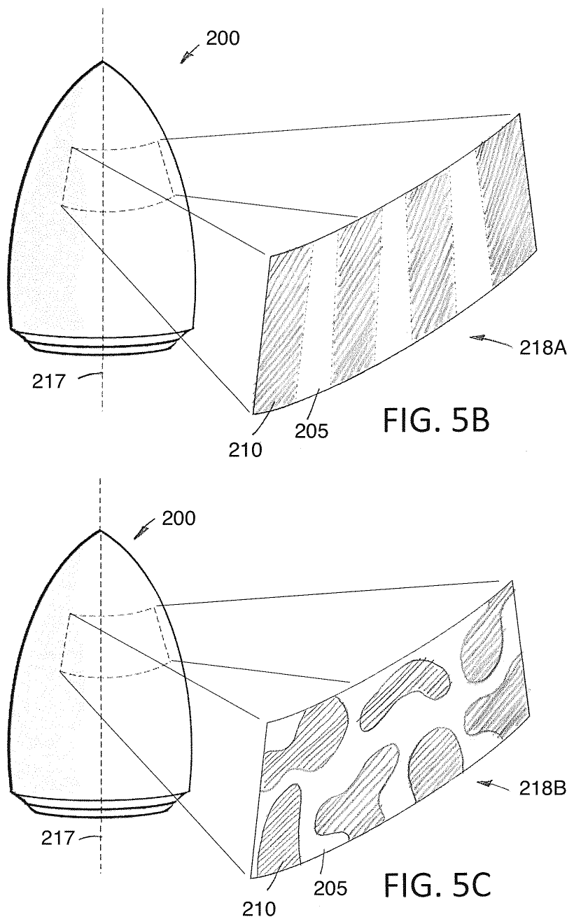

Now turning to FIG. 5A, another variation of a blender 200 is shown that is similar to that of FIGS. 1-2B except that includes a patterned surface having first porous surface features 205 adapted to controllably pick up cosmetic material during dabbing and second less porous surface features 210 adapted to tamp cosmetic materials during dabbing. This variation differs significantly from the prior art blender of FIG. 3, which simply has a porous sponge surface 65, which absorbs too much cosmetic material in the tamping stroke when dabbing simply because the cosmetic material further impregnates the sponge surface rather than primarily tamping the cosmetic materials.

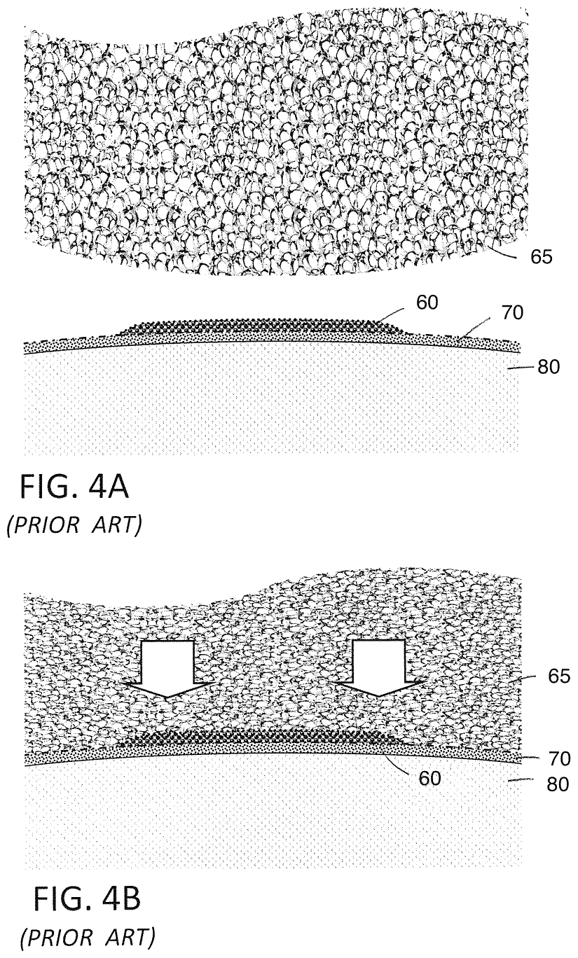

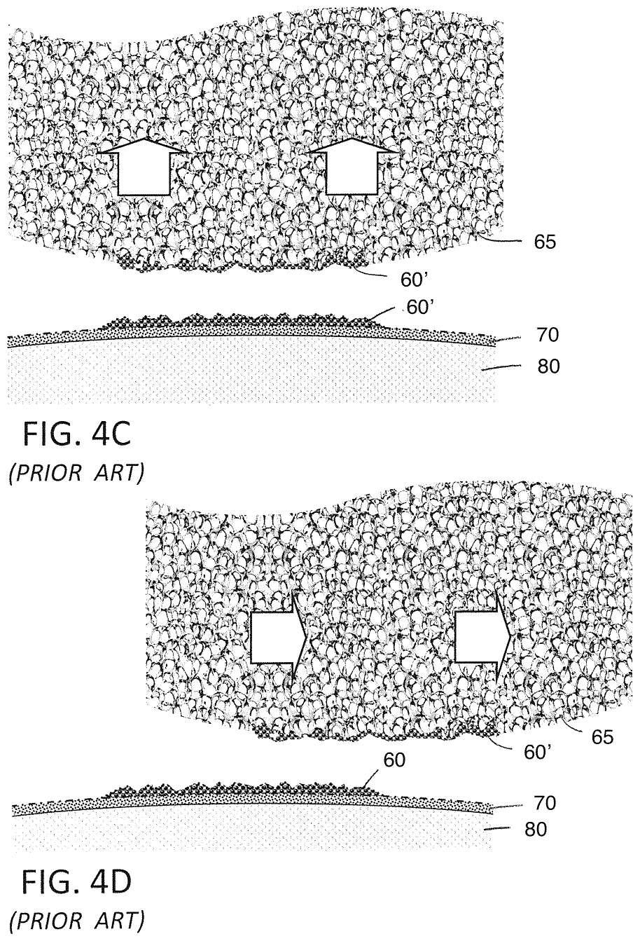

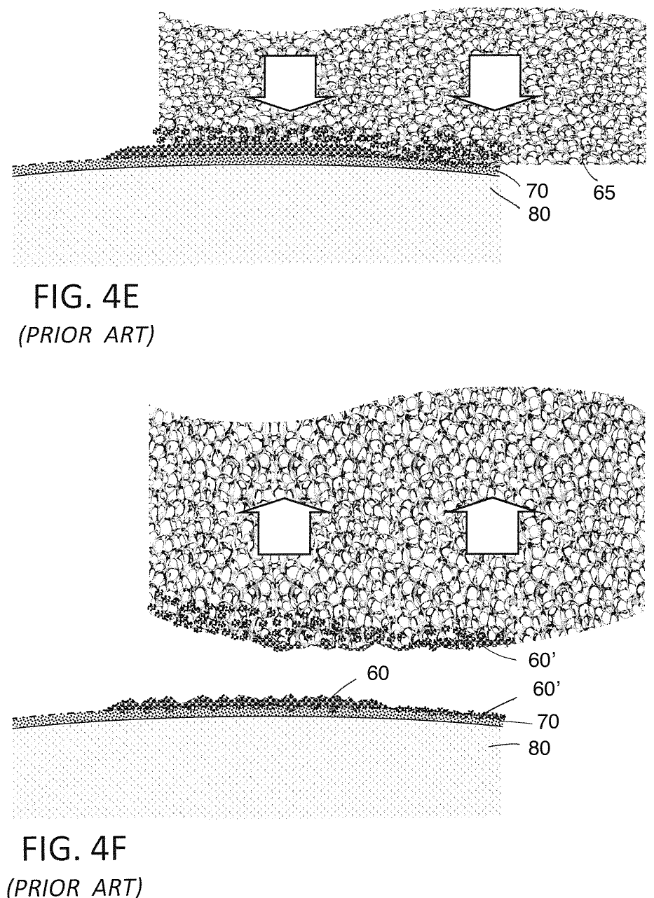

FIGS. 4A-4F help illustrate the sequence of steps in dabbing of the prior art sponge or blender of FIG. 3 wherein FIG. 4A shows the blender surface 65 above contouring makeup material 60, which was applied over a foundation layer 70 and the recipient's skin 80. FIG. 4B shows the blender surface 65 in the tamping stroke contacting the contour material 60. FIG. 4C illustrates the blender surface 65 after the lifting stroke with contour makeup 60′ picked up and carried by the surface 65. FIGS. 4D-4E then illustrate the blender surface 65 being moved laterally and then the tamping stroke against the patient's foundation layer 70 and skin. FIG. 4F illustrates the lifting stroke again wherein the blender surface 65 has redeposited some contour material 60′ laterally from the original contouring 60 to thereby blend the contouring makeup. However, the tamping stroke of FIG. 4E causes the cosmetic material to be impregnated into the sponge blender 65 and can limit the effectiveness of tamping the picked-up contour material 60′ into the foundation 70.

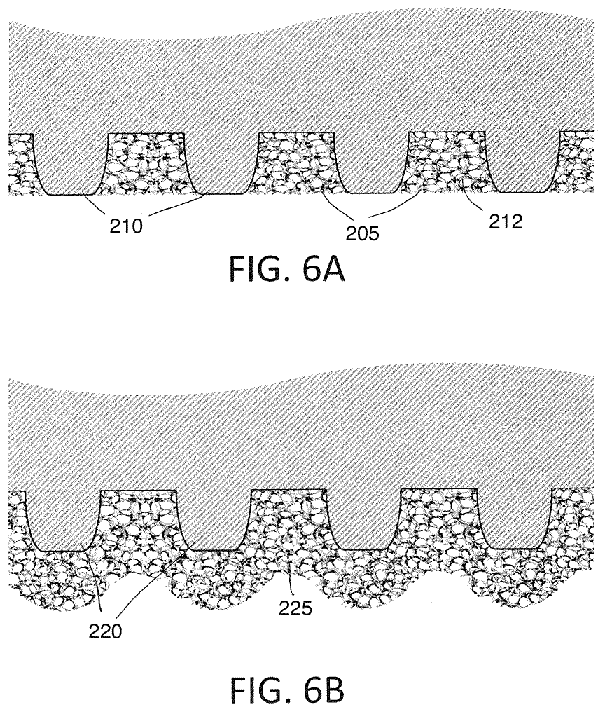

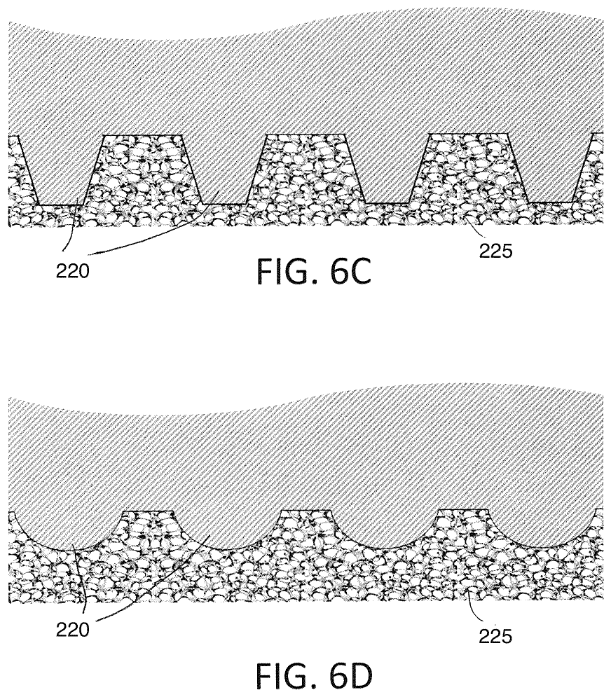

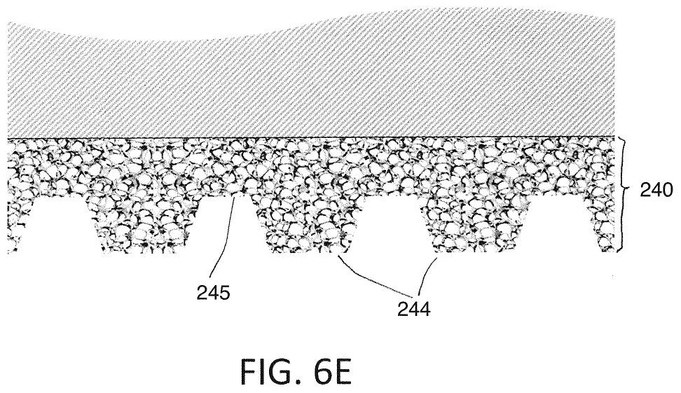

Now referring again to the blender 200 of FIG. 5A corresponding to the invention, it can be understood that a first surface portion 205 of the blender is configured to carry moisture and pick up cosmetic material in a controlled manner while the second surface portion 210 has lesser porosity or no porosity and is adapted for tamping cosmetic material into a foundation layer 70. FIG. 6A shows an exemplary cross-section of a small portion of the surface of the blender 200 of FIG. 5A, wherein porous open cell foam 212 is adapted for capturing moisture content and picking up cosmetic material. FIG. 6A further shows the second surface features 210 adapted for tamping such cosmetic materials.

It should be appreciated that the surface of the blender 200 is in FIG. 5A can have different patterns of surface features 205 and 210, wherein FIGS. 5B-5C shows a linear pattern 218A and a free-form pattern 218B. It can be understood that the linear patterns can be annular, diagonal, or aligned with the axis 217 of the blender.

FIGS. 6B-6D show other variations of cross-sections where the tamping features 220 are embedded within the foam layer 225. The variation of FIG. 6B also shows that the outermost surface 228 of the foam layer 225 may be textured. FIG. 6E shows a variation in which the foam layer 240 is textured, which when compressed, will cause the protruding regions 244 to function more as a tamping feature than regions 245 intermediate the protruding regions 244 to have a similar effect as the different density materials shown in FIGS. 6A and 6C.

In general, a cosmetic applicator or blender corresponding to the invention comprises a resilient body shaped for gripping with the fingers of a user, wherein a surface portion of the body comprises first and second resilient portions in a pattern, and wherein the first resilient portion has first functional parameters and the second resilient portion has second functional parameters. The first and second functional parameters are selected from the group of material density, open cell characteristics, closed cell characteristics, material density, elastic modulus, hydrophobic characteristics, hydrophilic characteristics, oleophobic characteristics, oleophilic characteristics, elastic rebound characteristics, material thickness and color coding. The pattern of the features is selected from the group of adjacent lines, dots, squares, polygonal shapes and free-form shapes. The surface of the resilient body in a repose state can be smooth or non-smooth and textured. As described in variations of FIGS. 1-2B, the surface portion of the blender is removable from a core portion of the blender, which has a fluid impermeable surface.

A method corresponding to the invention related to blending cosmetic materials comprises providing a resilient body having a surface portion comprising first and second resilient portions in a pattern, wherein the first resilient portion is porous and is more easily compressible than the second resilient portion in less porous or nonporous, providing instructions to the user wherein the user repeatedly dabs the surface portion against cosmetics on a recipient's skin to blend such cosmetics, wherein such dabbing is adapted to cause the first resilient portion to pick up and redeposit cosmetic material and the second resilient portion tamps the redeposited cosmetic material into cosmetic layers and the recipient's skin.

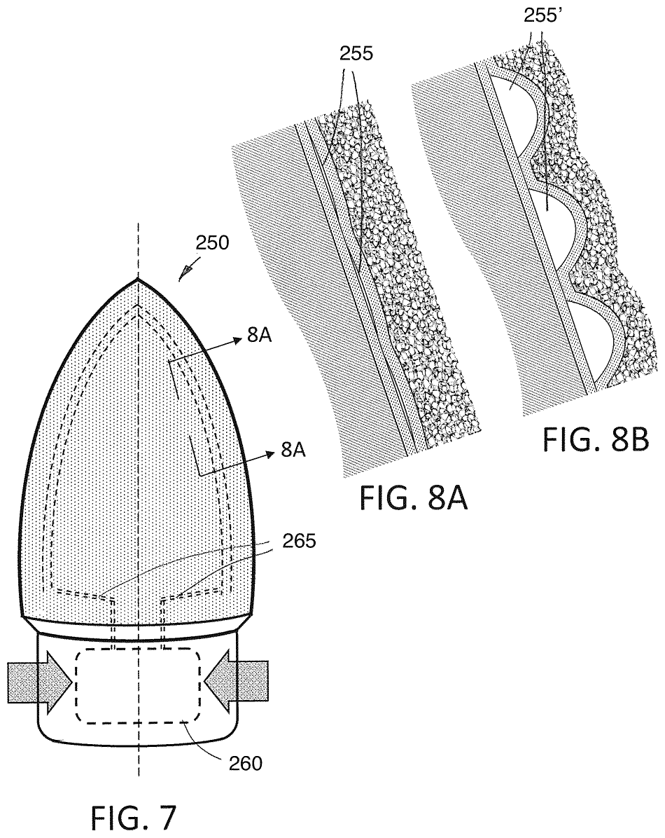

FIGS. 7, 8A and 8B are schematic views of another blender 250 that provides for fluidic actuation for providing or adjusting the tamping features 255 in the blender surface 256. As can be seen in FIG. 7, an interior chamber 260 is compressible with the user's fingers to cause fluid flow through channels 265 to bubbles, or expandable tamping features 255 and 255′ in FIGS. 8A and 8B to thus create or enhance the stiffness of such tamping features 255′. The elasticity of the materials causes a natural return flow of fluid media to the interior chamber 260. The fluid for actuating the tamping features can be either a liquid or simply air.

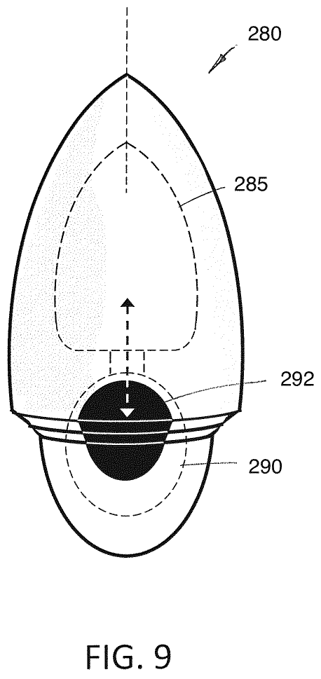

FIG. 9 is a view of another variation of a blender 280 with an internal bladder 285 with adjustable fluid pressure therein for altering the resilience or stiffness of the entire blender surface 288. In this variation, an interior chamber 290 is compressible with the user's fingers to provide a fluid flow into the bladder 285 to increase the stiffness or resistance to compression of the blender surface 288. As can be seen in FIG. 9, surface portions of the blender can have color markings 292 to indicate where the user's fingers can compress the interior chamber 290.

In general, a cosmetic applicator or blender comprises a body shaped for gripping with the fingers of a user, wherein a surface portion of the body has resilient characteristics, and wherein a bladder is carried in the interior of the body and an actuator is carried in the body for adjusting the fluid pressure in the bladder to alter the resilient characteristics of the surface portion. The actuator can be a manually compressible secondary bladder or interior chamber.

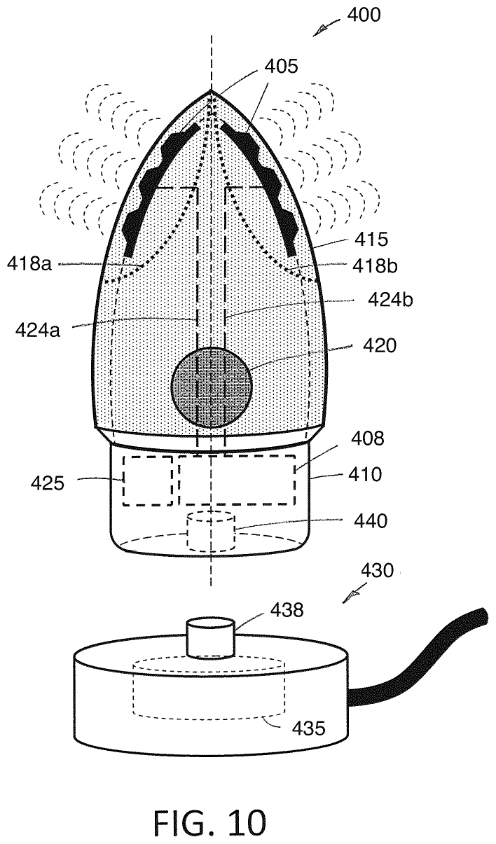

FIG. 10 illustrates another variation of a blender 400, which carries actuators 405 coupled to an energy source that can comprise a battery 408 within a core portion 410 of the blender. In this variation, the actuators are piezoelectric elements or ultrasound transducers that provide high-intensity ultrasonic waves for enhancing the tamping of cosmetic materials. The outer surfaces of such transducers may be in the surface 412 of the blender or slightly within an outer foam layer 415. Markings 418a and 418b are provided to indicate the location and directional orientation of such transducers. A push-button switch 420 is provided on the blender 400 to actuate the transducers. It can be seen that the electrical wires 424a and 424b couple the transducers 405 to the battery 408. The control unit 425 is provided to control the actuators 405 and may be adapted to operate in different modes, for example, with different frequencies or amplitudes. A base or stand 430 carries a recharging unit 435 that is provided for recharging the battery 408 is known in the art. The stand 430 can have a projecting element 438 that cooperates with receiving element 440 in the blender 400.

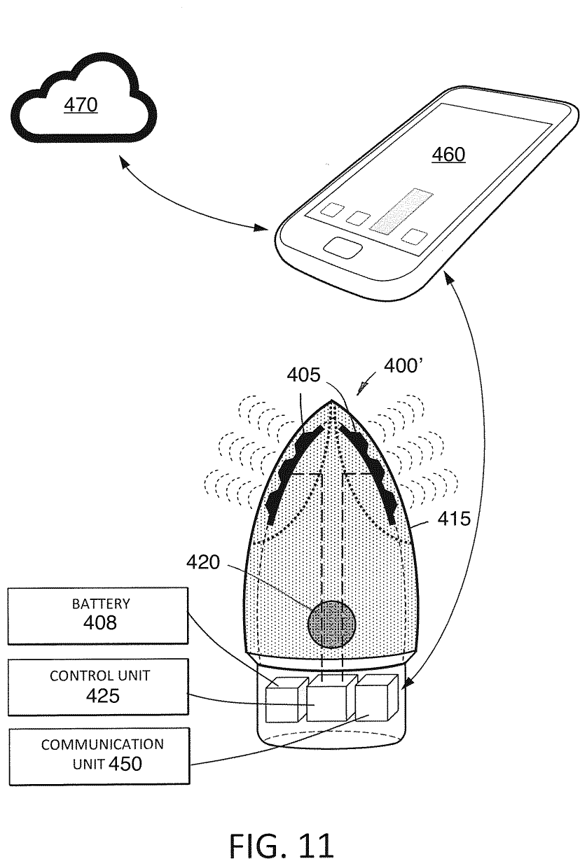

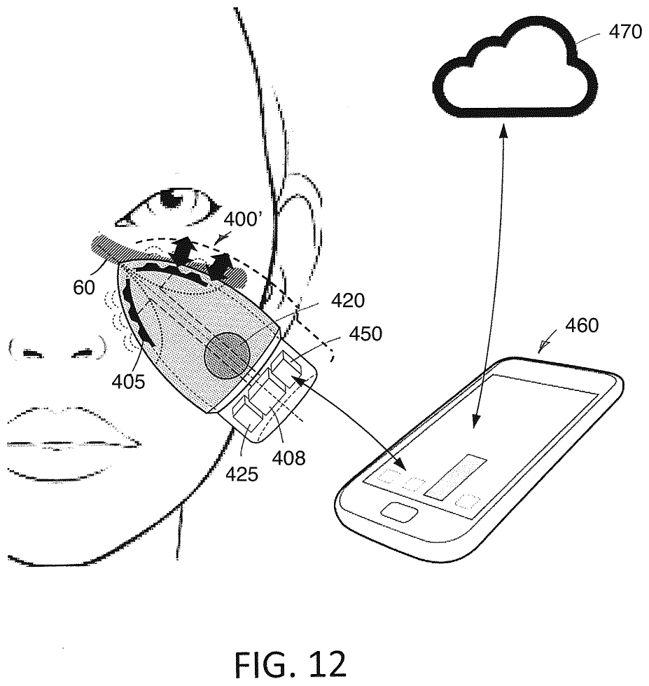

FIGS. 11 and 12 illustrate another variation of blender 400′, which is similar to that of FIG. 10 except that the blender of FIG. 11 carries an additional communications unit 450 adapted for communicating with a remote device such as a smartphone 460, a tablet, and/or the cloud 470. FIG. 12 illustrates a method of using the blender 400′ of FIG. 11 in blending the contouring makeup 60, wherein the ultrasound transducers 405 enhance the tamping of the cosmetic material as the blender is moved around the targeted skin surface.

In general, a cosmetic applicator corresponding to the invention comprises a body shaped for gripping with the fingers of a user, wherein the body has a surface portion comprising a resilient material and an electrically powered actuator in the body for actuating a surface portion of the body. The actuator is at least one of a fluidic actuator, a piezoelectric actuator, or a electromechanical actuator such as a linear resident actuator, eccentric rotating mass actuator, etc. The cosmetic applicator or blender can further carry a control unit for controlling operating parameters of the actuator or actuators. Further, the control unit can be configured to send and receive control signals wirelessly from a remote device, such a smartphone, tablet computer. In some variations, the actuator is configured to apply forces generally outward from the surface portion of the body. In other variations, the actuator is configured to apply forces generally parallel to surface portion of the body.

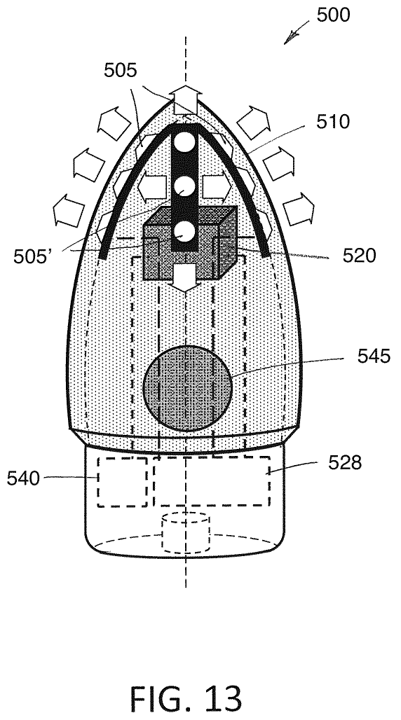

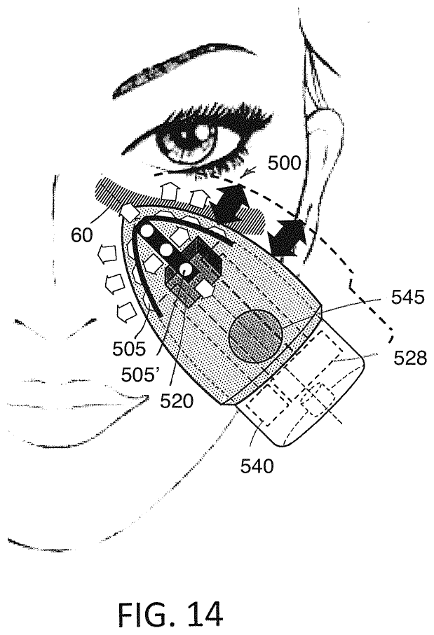

FIGS. 13 and 14 illustrate another variation of blender 500, which is similar to that of FIG. 11, except that the blender of FIGS. 13 and 14 carries transducers 505 that are adapted to apply tamping forces generally outward from the surface 510 of the blender and also carries transducers 505′ are adapted to apply forces generally parallel to the blender surface 514 to thus stretch the recipient's skin and foundation. Thus, the combination of tamping forces and stretching forces are adapted to more effectively blend cosmetic material.

Of particular interest, the blender 500 of FIG. 13 carries an accelerometer 520, which allows for sensing the user's movement of the blender. The accelerometer 520 can sense the tamping stroke and the lifting stroke to thus turn on and off the actuators 505, 505′ or selectively actuate the actuators 505, 505′ only for a fraction of the tamping stroke when in contact with skin which would optimize use. As can be seen in FIG. 13, the accelerometer 520 is coupled to the battery 528 and the control unit 540, which can further control the on-off amplitude and frequency of the actuators. In one variation, the control system 540 can sense the parameters the dabbing motion and can provide a tone or other indication to the user of the optimal dabbing rate or other useful operating suggestions. An actuator button 545 is shown for actuating the device. It should be appreciated that the blender 500 can carry a communications unit for communicating with remote device with a cloud as described previously.

FIG. 14 shows a method using the blender 500 of FIG. 13 to blend contouring makeup 60 into the patient's foundation and skin. In another aspect of the invention, it should be appreciated that the portion of the blender adapted for gripping with the user's fingers comprises a nonporous, wipe-clean surface to thus prevent the user's fingers from being covered with cosmetic material. The various embodiments above, the wipe-clean surface can extend around any actuator buttons in the blender. The shape of the disposable, porous surface component can then have a keyed shape for surrounding the projecting portions of the wipe-clean surface. In various embodiments, the disposable surface component can be keyed to cooperate with a keyed in the base component so that the disposable component is rotationally aligned with actuator elements in the base component.

In general, a cosmetic applicator or blender corresponding to the invention comprises a body shaped for gripping with the fingers of a user having a surface portion comprising a resilient material, and an accelerometer carried in the body for sensing movements of the body and providing signals of said movements. The blender further carries a control system configured to receive said signals from the accelerometer to thereby control an actuator carried by the blender body. The control system is further configured to receive signals from the accelerometer to thereby control an indicator mechanism carried by the blender to provide an aural signal, a visual signal, and a tactile signal. The control system can be further configured to receive accelerometer signals and transmit such signals to a remote device.

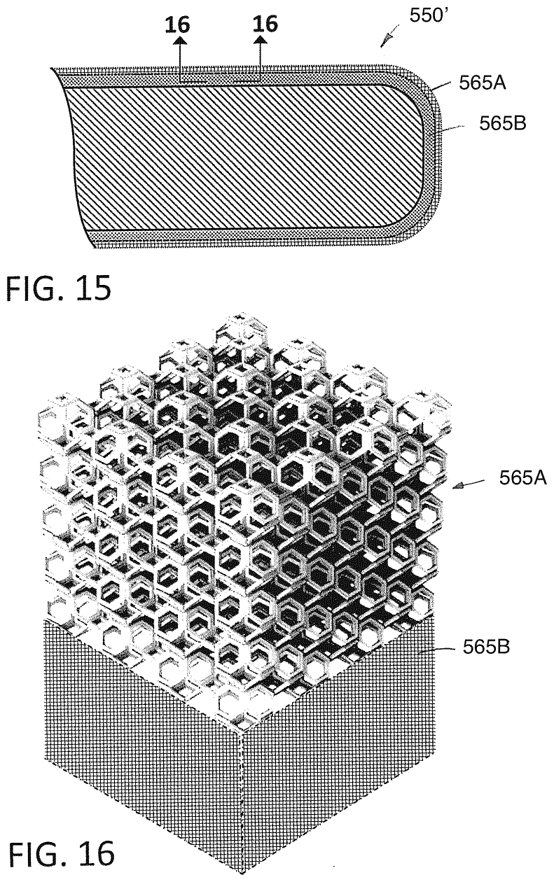

FIGS. 15 and 16 illustrate another blender 550 having a planar form with a surface component 560 comprising two surface layers, 565A and 565B having different porosity characteristics. FIG. 16 is a great enlarged cutaway view of the portion of the first and second surface layers 565A and 565B of FIG. 15 wherein in the outermost layer, 565A comprises material formed by soft lithography or 3D printing to have uniform pore sizes adapted for controllably picking up cosmetic materials, whereas the second interior 565B layer has different porosity characteristics which inhibit picking up cosmetic materials. Thus, the blender surface will prevent excessive migration of cosmetic material into the surface to conserve such cosmetic materials. At the same time, the innermost layer 565B is adapted to readily absorb water to carry the desired moisture content, which facilitates the blending of cosmetic materials.

It should be appreciated that other blenders can carry sensors capable of sensing contact with the skin, which can be coupled to a control unit 540 as described above to control actuators or indicators described above. Such sensors can consist of pressure sensors, impedance sensors, capacitance sensors, and the like. Further, a blender corresponding to the invention can carry LEDs coupled to the control unit 540 as in FIG. 11 for warming the cosmetic materials, cross-linking materials, or providing a signal to the user, for example, either with pulsed lighting or continuous lighting of the LEDs to indicate a suggested dabbing frequency or another recommended functional aspect of using the blender. In other variations, such LEDs can be provided in different colors or other aspects simply as a novelty feature.

In another variation (not shown), the blender can have a pore that carries a compact motor and pump that is adapted to provide fluid pulses through the porous surfaces of the blender of the type shown above to assist in the blending of the cosmetic materials. Inexpensive and disposable pumps are readily available and are adapted for use in the blender core portion that couples to separate foam surface portions.

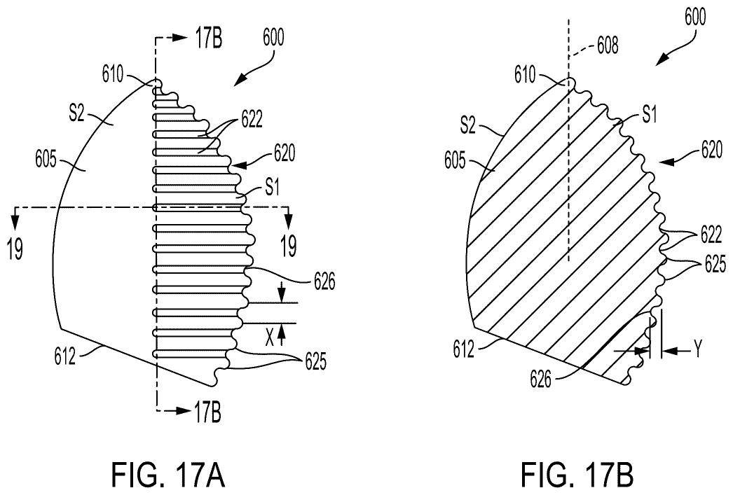

Now turning to FIGS. 17A and 17B, another variation of a cosmetic blender or applicator 600 is shown, which comprises a monolithic applicator body 605 of a fluid-permeable material such as an open cell foam of a hydrophilic polyurethane or a similar material as is known in the art. In FIG. 17B, it can be seen that applicator body 605 again has a tapered shape about a central axis 608 that extends to a superior or distal tip 610. The base 612 of the applicator body 605 can be angled or transverse to axis 608 and is shown as being angled. The cross-section of the applicator body 605 is typically round but also can be oval or polygonal. In the variation of FIG. 17A, at least a portion of the exterior of the applicator body 605 has an undulating surface 620 similar to that shown in FIGS. 6B and 6E above. In this variation, the undulating surface 620 comprises grooves or channels 622 that extend approximately 180° around the axis 608 in a first side 51 of the applicator body 605. An opposing side S2 of the applicator body 605 is smooth in the variation of FIG. 17A-17B. Each channel 622 has a spacing or width X between crests of adjacent ridges 625 ranging from 1 mm to 6 mm. The depth Y of each channel 622 from the channel bottom 626 to the crest of each ridge 625 ranges from 0.5 mm to 6 mm. A typical applicator body 605 for use in facial makeup blending would have channel widths X ranging from 1 mm to 3 mm and similar channel depths from 0.5 mm to 3 mm. A large applicator body of the type used in body makeup may have larger channel widths and depths as described above.

FIG. 17B is a sectional view of the applicator of FIG. 17A showing that the applicator body 605 comprises a monolithic open cell foam which can be fabricated by (i) pouring a liquid foam precursor into a mold, (ii) allowing the liquid precursor to expand and transition to an open cell foam which will have a fluid impermeable boundary or skin after expansion, (iii) removing the foam from the mold, and (iv) milling or cutting away the exterior of the foam into a desired shape of an applicator body.

The undulating surface 620 of an applicator 600 is shown in FIGS. 17A-17B and performs an important function in efficiently applying makeup. As illustrated in FIGS. 18A-18B, an undulating surface 620 can distribute makeup 640 across a user's skin 642 when used in a conventional manner of rapid tamping of the undulating surface 620 over a smear of makeup 640 applied to the skin 642. When tamping the undulating surface 620 of side 51 of the applicator body 605 against the skin, the progressive compression of each ridge 625 or projecting portion of the undulations 620 can cause slight sideways or lateral forces on the makeup 640 as such features contact the makeup, which differs from an applicator with a smooth surface that only applies forces on the makeup in the vector of tamping movement. Such slight lateral forces are indicated by arrows 645 in FIG. 18B, which shows a compressed undulating surface 620′ with the repose undulating surface 620 shown in a dashed line. Following the repetitive tamping as shown in FIGS. 18A-18B, the user can then use the smooth side S2 of the applicator body 605 to provide a final blended makeup.

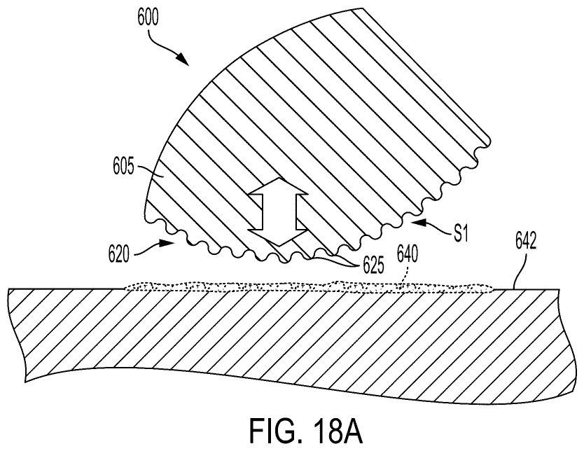

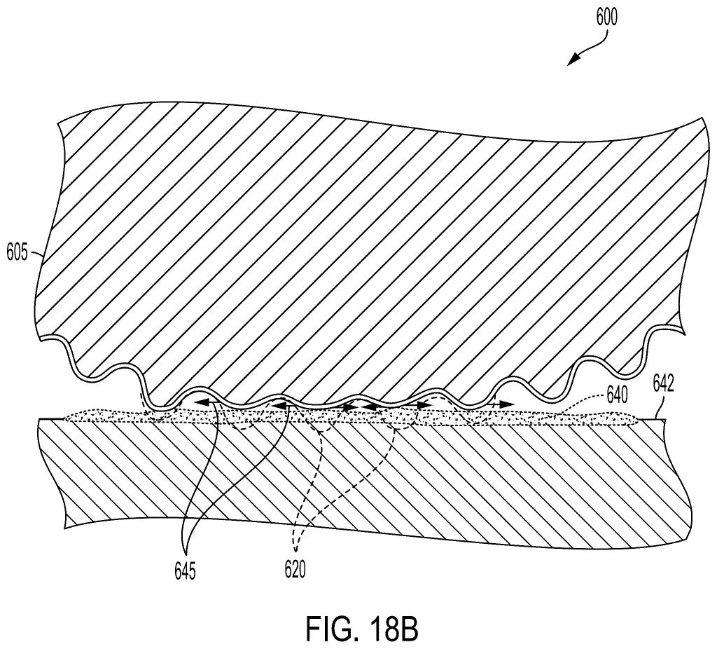

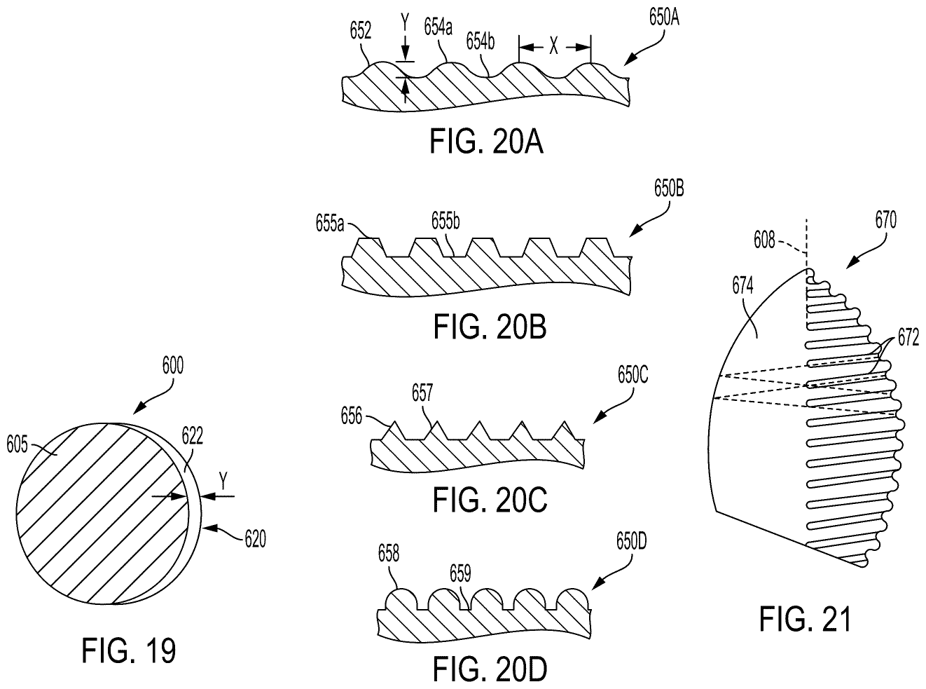

Thus, the use of an applicator body 605 with an undulating or textured surface allows for a more rapid and effective application of makeup. FIG. 19 is a transverse sectional view of the applicator body 605 of FIGS. 17A-17B showing that the depth of each channel 622 may progress from a zero depth and ends of the channel to a maximum depth Y in the middle of the channel length around the surface of the applicator body 605. Alternatively, the channels 622 can have a constant depth from one side of the applicator body 605 to the opposing side.

FIGS. 20A-20D are enlarged sectional views of variations of undulating surfaces 650A-650D, respectively, with various shaped ridges with rounded or non-rounded features that are within the scope of the invention. In FIG. 20A, a typical undulating surface 650A can comprise ridges 652 with rounded crests 654a and rounded valleys 654b therebetween with the spacing X and depth Y as described above. In another variation shown in FIG. 20B, the ridge crests 655a and groove bottoms 655b are more angular. FIG. 20C shows another variation of an undulating surface where the ridges 656 have a pointed crest or apex 657. FIG. 20D shows a variation of an undulating surface 650D with rounded ridges 658 spaced closely together with narrow channels 659.

FIG. 21 is another variation of a cosmetic applicator 670 that is similar to the variation of FIG. 17A except that the grooves 672 are helical or angled relative to axis 608 of the applicator body 674.

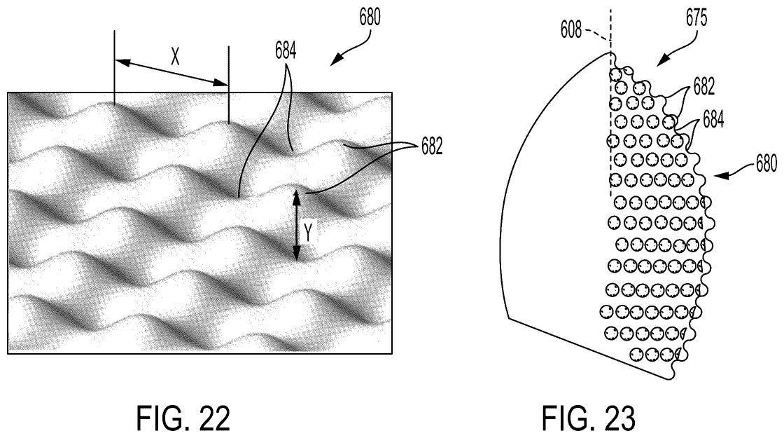

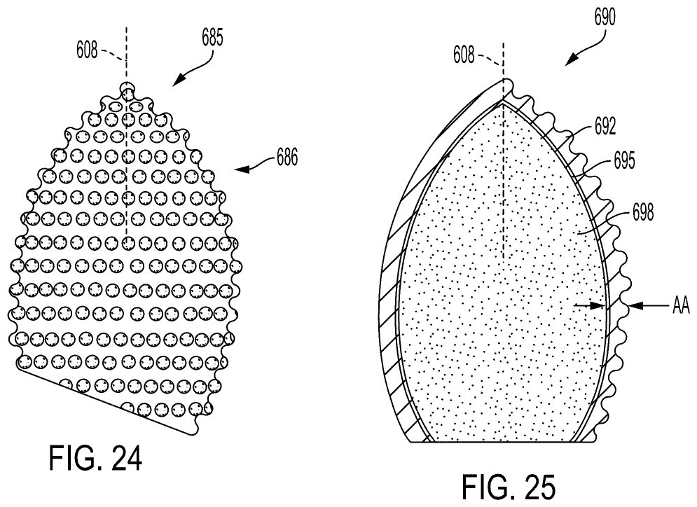

FIGS. 22 and 23 show another variation of an applicator 675 where the undulating surface 680 comprises individual projecting features 682 with valleys 684 between the projecting features. The variation of FIG. 22 again illustrates a variation where the undulating surface 680 comprises 180° of the circumferential surface around axis 608 of the applicator 675, although any circumferential dimension between 90° and 360° is within the scope of the invention. FIG. 24 shows an applicator body 685 that has a textured or undulating surface 686 similar to that of FIG. 22 that extends around all surfaces of the applicator. Such an applicator 685 may be used in combination with a separate smooth-surfaced applicator for rapid application and distribution of makeup when larger applicators are used, for example, in filmmaking where body makeup is being applied.

FIG. 25 shows another variation of applicator 690, which is similar to that of FIG. 17A wherein a surface portion 692 comprises an open cell, fluid permeable foam material as described above. However, the applicator 690 differs from the variation of FIG. 17A in that a fluid impermeable boundary 695 is provided between the surface portion 692 and a resilient core 698 as in the variation of FIG. 7E above. The core 698 typically is an open cell foam, but other resilient cores can be used, such as spring-assisted cores as described commonly-owned and invented U.S. Pat. No. 11,019,906 titled “Hygienic Cosmetic Applicator and Method of Use.” In a variation of the type shown in FIG. 25, the thickness AA of the surface portion 692 can range from 1 mm to 8 mm, and often is from 2 mm to 5 mm in an applicator designed for applying facial makeup.

The use of a fluid impermeable boundary 695 underlying the absorbent surface portion 692 is important and allows for less waste of makeup product since makeup can only migrate into the surface portion 692 instead of the entire body of the applicator 690. As is known in the art, an absorbent applicator is typically wettened before use which helps absorb, distribute and blend makeup. Thus, in this variation, the fluid permeable surface portion 692 comprises less than 50% of the applicator volume, or less than 30% or less than 20% of the applicator volume. The surface portion 692 of the applicator 690 can be rinsed, cleaned, and dried much more quickly than an applicator that consists of a monolithic open cell foam body that absorbs water and makeup throughout the applicator body. In another variation, the surface portion 692 and fluid impermeable boundary 695 can comprise a detachable, replaceable component that can be separated from the resilient core 698. In such a variation, the core 698 can be used for many more makeup applications than the replaceable surface portion 692.

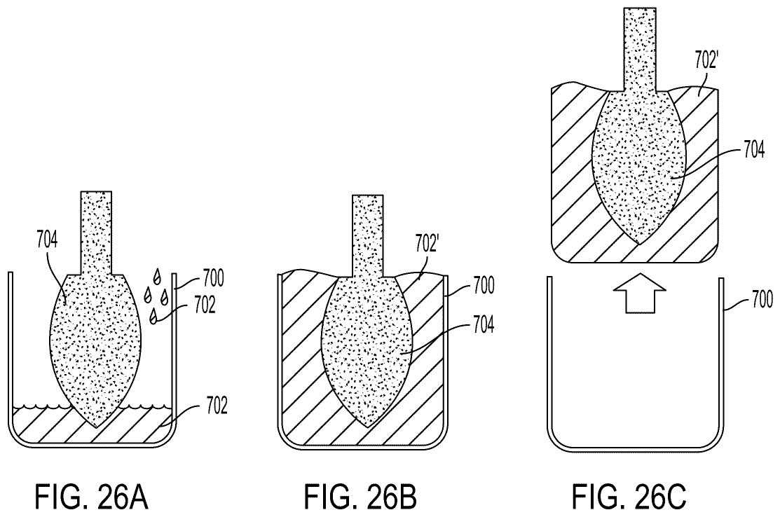

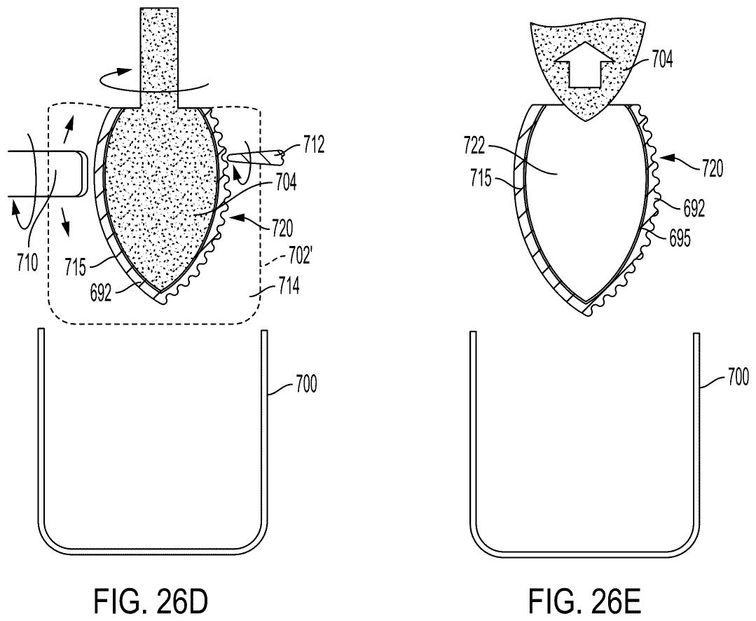

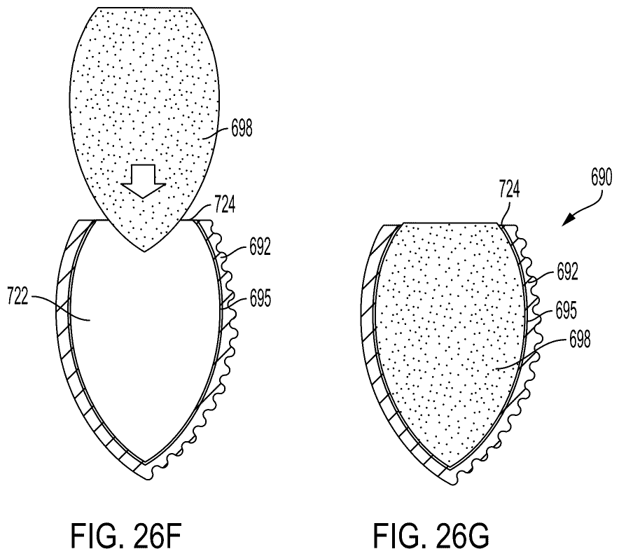

FIGS. 26A-26G show a method of making an applicator 690 of the type shown in FIG. 25, where the applicator has an open cell surface portion 692 with a fluid impermeable boundary 695 at the interface with a core portion 698. In FIG. 26A, it can be seen that a mold 700 is dimensioned to receive a liquid precursor 702 to an open cell foam with a mandrel or core 704 positioned in the mold 700. FIG. 26A shows the liquid precursor 702 being poured into the mold 700, and FIG. 26B shows the liquid precursor 702 after transiting to an open cell foam block 702′ around the mandrel 704. FIG. 26C then shows the foam block 702′ and mandrel 704 being lifted or removed from the mold 700.

FIG. 26D then shows the molded foam 702′ together with mandrel 704 after being lifted from mold 700 with cutting tools, for example tools 710 and 712, being used to remove exterior portions 714 of the foam block 702′ until the final shape of the outer surface portion 692 is completed. The cutting tools can consist of various types of suitable tools, such as milling tools, cutters, grinders, sanders, laser cutters, and high-velocity jetting cutters. FIG. 26D shows the optional tools 710 and 712 being used to mill a smooth surface 715 on one side of the applicator 690 and an undulating surface 720 on the opposing side of the applicator 690. In some cases, the shaping is accomplished with the foam block 702′ at an ambient temperature, or the foam block can be cooled to less than 10° C. to make it more suitable for cutting. FIG. 26E then shows the mandrel 704 being removed or lifted outwardly from the separable surface portion 692, leaving an open cavity 722 therein.

FIG. 26F next shows the surface portion 692 after separation from the mandrel 704 with a foam core 698 as in FIG. 25 being inserted into cavity 722 in the open cell surface portion 692. FIG. 26G next shows the foam core 698 fully inserted into cavity 722 in the surface portion 692. Thus, the assembled components of FIG. 26G then comprises an assembled applicator 690 as in FIG. 25 with the fluid impermeable boundary 695 between the surface portion 692 and the core 698. The two components (surface portion 692, core 698) can be maintained to be separable or can be adhered to one another with an adhesive. In any event, the applicator body 690 has a surface portion 692 of a fluid permeable foam overlying a fluid impermeable boundary 695 with a resilient core 698. The resilient core 698 the FIGS. 26F and 26G can be fabricated using the same steps described above without using a mandrel. In other words, a foam precursor can be poured into a mold 700, which thereafter transitions into an open cell foam which is then milled or cut into the shape of core 698, which matches the shape of cavity 722 in surface portion 692 of FIGS. 26D and 26E. In another variation, not shown, the separated surface portion 692 of FIG. 26D can be used as a mold to receive a liquid precursor wherein the resulting open cell foam would then form within the cavity 722 in the surface portion 692. In this variation, the surface portion 692 and foam core 698 would not be separable from one another but would be bonded at the interface between the two components. In this variation, only the base of the applicator 680 then would need to be trimmed as the expanding pen cell foam of the core would typically bubble outside the opening 724 in the separated surface portion 692 of FIG. 26D.

Although particular embodiments of the present invention have been described above in detail, it will be understood that this description is merely for purposes of illustration and the above description of the invention is not exhaustive. Specific features of the invention are shown in some drawings and not in others, and this is for convenience only and any feature may be combined with another in accordance with the invention. A number of variations and alternatives will be apparent to one having ordinary skills in the art. Such alternatives and variations are intended to be included within the scope of the claims. Particular features that are presented in dependent claims can be combined and fall within the scope of the invention. The invention also encompasses embodiments as if dependent claims were alternatively written in a multiple dependent claim format with reference to other independent claims

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

What is claimed is:

1. A cosmetic applicator comprising:
a resilient foam body shaped for gripping with fingers of a user;
a portion of the resilient foam body comprising an undulating surface having peaks and valleys therein; and
wherein the undulating surface comprises an open-cell foam.

2. The cosmetic applicator of claim 1 wherein the resilient foam body has a tapered shape extending to a tip, wherein the tip is pointed or rounded.

3. The cosmetic applicator of claim 1 wherein a height dimension from a valley to a peak of the undulating surface is between 0.5 mm and 5 mm.

4. The cosmetic applicator of claim 1 wherein a lateral dimension from peak to peak is between 1 mm and 10 mm.

5. The cosmetic applicator of claim 1 wherein the undulating surface comprises a plurality of elongated ridges and a plurality of elongated valleys, where the plurality of elongated ridges are spaced apart with the plurality of elongated valleys located between the plurality of elongated ridges.

6. The cosmetic applicator of claim 5 wherein the plurality of elongated ridges include at least one linear ridge.

7. The cosmetic applicator of claim 6 wherein the at least one linear ridge extends at least one of axially, circumferentially and angularly relative to an axis of the resilient foam body.

8. The cosmetic applicator of claim 1 wherein the undulating surface comprises a plurality of crests that are spaced apart with valleys therebetween.

9. The cosmetic applicator of claim 8 wherein the plurality of crests are rounded.

10. The cosmetic applicator of claim 8 wherein the plurality of crests are non-rounded.

11. The cosmetic applicator of claim 1 further comprising a non-permeable layer between a surface region and an interior core of the foam body.

12. A cosmetic applicator comprising:
a resilient foam body shaped for gripping with fingers of a user;
a first surface portion of the resilient foam body comprising a non-smooth surface having peaks and valleys therein, wherein the non-smooth surface comprises an open-cell foam; and
a second surface portion of the resilient foam body having a smooth surface.

13. A cosmetic applicator comprising:
an applicator body shaped with a tapered shaped extending to an apex, the applicator body adapted for gripping with fingers of a user;
the applicator body comprising a resilient surface region overlying a resilient core;
wherein at least the resilient surface region comprises a fluid permeable portion and a fluid impermeable portion.

14. The cosmetic applicator of claim 13 wherein the fluid permeable portion comprises an open-cell foam.

15. The cosmetic applicator of claim 13 wherein the fluid impermeable portion comprises resilient beads or spheres.

16. The cosmetic applicator of claim 13 wherein the fluid impermeable portion comprises a boundary between the resilient surface region and the resilient core.

17. The cosmetic applicator of claim 16 wherein the boundary is from 1 mm to 8 mm inward from an exterior of the resilient surface region.

18. The cosmetic applicator of claim 13 wherein the applicator body has an undulating surface with peaks and valleys therein.

19. The cosmetic applicator of claim 18 wherein a height dimension from a valley to a peak of the undulating surface is between 0.5 mm and 5 mm.

20. The cosmetic applicator of claim 13 wherein a lateral dimension from peak to peak is between 1 mm and 10 mm.

21. The cosmetic applicator of claim 13 wherein the resilient surface region is removable from the resilient core.

22. A method of making a cosmetic applicator with a fluid permeable surface and a fluid impermeable layer around a core, the method comprising:
providing a mold;
positioning a core in the mold;
pouring a liquid foam precursor into the mold and allowing the liquid foam precursor to transform into a resilient foam body around the core with a fluid impermeable surface interfacing the core;
removing the resilient foam body and core from the mold;
shaping the resilient foam body into a tapered shape for gripping with fingers of a user.

23. The method of making a cosmetic applicator of claim 22 wherein shaping is accomplished by at least one of milling, cutting, grinding, sanding, laser cutting, media blasting and water-jet material removal.

24. The method of making a cosmetic applicator of claim 22 wherein shaping is accomplished with the resilient foam body at an ambient temperature or at less than 10° C.

25. The method of making a cosmetic applicator of claim 22 wherein at least a portion of a surface of the tapered shape is smooth.

26. The method of making a cosmetic applicator of claim 22 wherein at least a portion of a surface of tapered shape has surface features selected from a group of ridges, grooves, projections, channels, undulations and recesses.

27. The method of making a cosmetic applicator of claim 22 wherein the core is removed and replaced with a foam core.

28. The method of making a cosmetic applicator of claim 22 wherein the core comprises a foam.

29. The method of making a cosmetic applicator of claim 22 wherein the core is selected from a group of a foam material and a structure carrying a spring element.
